(19) United States
(12) Patent Application Publication
(10) Pub. No.: US 2014/0282285 A1
(43) Pub. Date: Sep. 18, 2014

(54) MODIFYING A USER INTERFACE SETTING BASED ON A VISION ABILITY OF A USER

(71) Applicant: CELLCO PARTNERSHIP D/B/A VERIZON WIRELESS, (US)

(72) Inventors: Rita SADHVANI, Watchung, NJ (US); Hannah Y. MOON, Boston, MA (US)

(73) Assignee: CELLCO PARTNERSHIP D/B/A VERIZON WIRELESS, Basking Ridge, NJ (US)

(21) Appl. No.: 13/829,929

(22) Filed: Mar. 14, 2013

(51) Int. Cl. G06F 3/048

(52) U.S. Cl. CPC G06F 3/048
USPC 715/865

(57) ABSTRACT

A user interface setting of a computing device is automatically adjusted, based on a vision ability of a user of the device. In some examples, visual information output for a user of a computing device is presented via at least one user input/output element of the computing device. Responsive user input is received via the at least one user input/output element. The received responsive user input is analyzed to automatically determine a vision ability of the user. A setting of a user interface of the at least one user input/output element of the computing device is automatically adjusted based on the determined vision ability of the user.

### BACKGROUND

In recent years, computing devices, for example, laptop computers, desktop computers, mobile phones, tablet computers, personal digital assistants, portable electronic music players, and televisions have become more popular, with users typically owning one or more of the above devices, and using these devices regularly. Computing devices typically have a user interface with a visual element (e.g., a display internal to the device or coupled to the device) for providing information to the user.

Some users of computing devices have poor vision (e.g., nearsightedness, farsightedness, astigmatism, colorblindness, or unusual light sensitivity). As a result, the user may have difficulty operating a computing device. For example, the user may need to put on his/her eyeglasses to use the computing device or hold the computing device very close to his/her face.

To solve this problem, the user could manually adjust user interface settings (e.g., default font size, default screen brightness, etc.) of the computing device. However, adjusting user interface settings may be a tedious process, and some users may not know that user interface settings on a computing device can be adjusted. Alternatively, a user may know that user interface settings can be adjusted, but may not know how to adjust the settings or may not be motivated to figure out how to adjust the settings (e.g., by reviewing the owner's manual of the computing device).

As the foregoing illustrates, a need exists a technology to automatically modify a user interface setting of a computing device based on a vision ability of a user of the device.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an example of a system for modifying a user interface setting based on a vision ability of a user.

FIG. 2 illustrates an example of the client computing device of FIG. 1.

FIG. 3 illustrates an example of a server of FIG. 1, which hosts a data repository for user interface settings corresponding to vision abilities.

FIG. 4 illustrates an example of the data repository of FIG. 1.

FIG. 5 is a flow chart illustrating an exemplary process for automatically modifying a user interface setting based on a vision ability of a user.

FIG. 6 is a flow chart illustrating an exemplary process for automatically adjusting the setting of the user interface based on the determined vision ability of the user.

FIG. 7 is a flow chart illustrating an exemplary process for providing a user interface setting to a client computing device.

FIG. 8 is a simplified functional block diagram of a computer that may be configured as a host or server.

FIG. 9 is a simplified functional block diagram of a personal computer or other work station or terminal device, which may be another example of a computing device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various techniques disclosed herein relate to automatically modifying a user interface setting of a computing based on a vision ability of a user of the device.

In the examples discussed below, a computing device determines a vision ability of the user. The vision ability could be determined during initial setup of the computing device while running a setup wizard application. For example, the computing device could provide a vision test for the user, the user could scan or photograph his/her eyeglasses prescription, or the user could manually input information about his/her vision ability. An interface setting, for example, for a visual output via a display, is then automatically adjusted based on the determined ability of the user.

In some examples, a vision test to determine a vision ability of a user can be provided via a computing device. For example, the user could be prompted to read characters displayed on a screen of the computing device or indicate a direction in which an arrow on the screen is pointing. The vision test could be similar to a vision test provided by an optometrist for the purpose of providing an eyeglasses prescription.

The vision ability of the user can relate to, for example, eyeglasses prescription(s), color blindness, or light sensitivity of the user. To determine light sensitivity, a user could be presented different brightness and/or contrast levels and asked to select the brightness and/or contrast level that he/she prefers.

Upon determining the vision ability of the user, the computing device adjusts one or more user interface settings based on the determined vision ability. In some examples, the user interface setting(s) relate to a visual output of the computing device. The user interface setting(s) can include: a default font size, a default zoom level, a default font size/zoom level combination, a touch point size or sensitivity level, color setting(s), etc. After the computing device adjusts the one or more user interface settings, the user can further adjust the user interface settings. For example, if the computing device sets the default font size to 18 points, the user can further adjust the default font size to 20 points.

In some examples, a data repository accessible via network communication stores data structure(s) mapping vision abilities to user interface settings, e.g. for particular types of computing devices. After receiving vision ability information for the user, the computing device adjusts the user interface settings based on data obtained from the data repository. When the user later changes the user interface settings (or selects one of multiple user interface settings proposed to the user), the computing device notifies a server coupled with the data repository. If a threshold number of users (e.g., three users or sixty users) make a certain change or selection, the data repository can be updated accordingly. For example, if users having −5 vision are asked, based on information in the data repository, to choose between a default font size of 18 points, 24 points, 36 points, and 48 points; but six consecutive users having −5 vision select the 24 point font size, the data repository could be updated to only offer the 24 point font size to computing devices of future users having −5 vision.

In some examples, the data repository could store range(s) of vision abilities that correspond to predetermined user interface setting(s). For example, for a vision range between −2 and −5 diopters, the default font size can be 16 points. For a vision range between −6 and −8 diopters, the default font size can be 24 points. As used herein, the phrase “−N diopters” encompasses its plain and ordinary meaning. A person having a vision of −N diopters can clearly focus on visual information a distance of N in front of his/her eyes. For example, a person with a vision of −2 diopters can clearly focus on content 2 meters in front of his/her eyes but may have difficulty reading a printed page or information on a screen of a computing device immediately in front of himself/herself. According to some optometrists, for nearsightedness, diopter measures of −0.1 through −3 are considered mild, −3 through −6 are considered moderate, and diopter measures beyond −6 are considered severe.

FIG. 1 illustrates an example of a system 100 for modifying a user interface setting of a computing device 110, based on a vision ability of a user of the client computing device 110. As shown, the system 100 includes the client computing device 110, a computer configured as a server 120, and a data repository 130. The client computing device 110, the server 120, and the data repository 130 communicate with one another via a network 140. In some examples, the data repository 130 is a component of the computer configured as the server 120, and the server 120 does not use the network 140 to communicate with the data repository 130. The network 140 may include a cellular network, the Internet, an intranet, a local area network, a wide area network, a wired network, a wireless network, or a virtual private network (VPN). While only one data repository 130, server 120, and client computing device 110 are illustrated, the subject technology may be implemented in conjunction with any number of data repositories 130 or servers 120, which can support adjustment of user interface settings for any number of client computing devices 110. In some aspects, a single machine may implement the functions of two or more of the data repository 130, the server 120, or the client computing device 110. In some examples, a single device performs the functions of all three of the client computing device 110, the server 120, and the data repository 130. The single device may perform these functions without accessing the network 140.

The data repository 130 stores a data structure representing a mapping of vision abilities to recommended user interface settings. One example of the data repository 130 is described in more detail in conjunction with FIG. 4 below.

The server 120 includes one or more modules for providing user interface settings to the client computing device 110. The one or more modules can be implemented in software. The one or more modules can include data, code, or a combination of data and code. The server 120 may be implemented as a single machine with a single processor, a multi-processor machine, or a server farm including multiple machines with multiple processors. One example of the server 120 is described in more detail in conjunction with FIG. 3 below.

The client computing device 110 may be a mobile phone, a personal digital assistant (PDA), a tablet computer, a netbook, a laptop computer, a desktop computer, a television with one or more processors embedded therein or coupled thereto, etc. The client computing device 110 may include one or more user input/output elements, for example, a display, a touch screen, a speaker, a microphone, a keyboard, or a mouse. One example of the client computing device 110 is described in more detail in conjunction with FIG. 2 below.

According to some examples, the client computing device 110 determines a vision ability of a user and communicates with the server 120 to determine the appropriate user interface settings based on the determined vision ability. The server 120 looks up the appropriate user interface settings for the determined vision ability in the data repository 130 and communicates the appropriate user interface settings to the client computing device 110. The client computing device 110 updates the user interface of the client computing device 110 based on the appropriate user interface settings. Alternatively, all or a portion of the information stored at the server 120 or at the data repository 130 could reside on the client computing device 110. As a result, the client computing device 110 may modify the settings of the client computing device 110 based on the determined vision ability of the user without accessing the network 140, the server 120, or the data repository 130.

FIG. 2 illustrates an example of the client computing device 110 of FIG. 1. As shown, the client computing device 110 includes a central processing unit (CPU) 202, a network interface 204, a camera 205, and a memory 206. The CPU 202 includes one or more processors. The CPU 202 is configured to execute computer instructions that are stored in a computer-readable medium, for example, the memory 206. The network interface 204 is configured to allow the client computing device 110 to transmit and receive data in a network, e.g., network 140 of FIG. 1. The network interface 204 may include one or more network interface cards (NICs). The memory 206 stores data or instructions. The memory 206 may be one or more of a cache unit, a storage unit, an internal memory unit (e.g., a hard disk internal to a computing device), or an external memory unit (e.g., a removable universal serial bus, compact disk, or floppy disk memory). As illustrated, the memory 206 includes a vision ability determination module 208, vision ability information 210, a user interface (UI) setting(s) adjustment module 212, and UI setting(s) 214. The vision ability determination module 208 and/or the UI setting(s) adjustment module 212 can be implemented in software. The vision ability determination module 208 and/or the UI setting(s) adjustment module 212 can include data, code, or a combination of data and code. The camera 205 is configured to receive visual input from the surrounding environment of the client computing device 110. For example, the camera 205 can be used to take photograph(s) or scan document(s). The photograph(s) taken by the camera 205 or the documents scanned by the camera 205 can be stored in the memory 206. While the client computing device 110 is illustrated as including the camera 205, in some examples, the client computing device 110 can be implemented without the camera 205.

The vision ability determination module 208 configures the computing device to determine the vision ability information 210 for a user of the client computing device. In some aspects, the vision ability information 210 is determined, as described below, via the vision ability determination module 208, during initial setup of the client computing device 110 while running a setup wizard application. The vision ability determination module 208 may be a component of the setup wizard application. Alternatively, the vision ability determination module 208 may be separate and distinct from the setup wizard application. The setup wizard application may, upon receiving a user input for adjusting the user interface of the client computing device 110 based on the vision ability of the user, invoke the vision ability determination module 208. Alternatively, a user may manually cause execution of the vision ability determination module 208, for example, when the user detects that his/her vision ability has changed or when ownership of the client computing device 110 is transferred. The user may manually cause the execution of the vision ability determination module 208 by selecting an application corresponding to the vision ability determination module 208 on the screen of the client computing device 110 or within an adjust settings application of the client computing device 110. The vision ability determination module 208 may be a component of the adjust settings application. The vision ability determination module 208 is a software module that includes software code for performing the operation(s) described herein. In some implementations, the vision ability determination module 208 operates by asking, via the display or via an audio output, the user to input (e.g., via a keyboard or a keypad) his/her vision information. In some implementations, the vision ability determination module 208 scans an eyeglasses prescription and determines the vision ability information 210 based on the scanned eyeglasses prescription. For example, if the client computing device 110 includes the camera 205, the user may take a photograph of the eyeglasses prescription. Alternatively, the user, an optometrist, or any other person can input the prescription in other ways, for example, by speaking the prescription into a microphone or audio input of the client computing device 110, if the client computing device 110 includes a microphone or audio input.

In some examples, when the vision ability determination module 208 is executed, the operation of the vision ability determination module 208 configures the computing device to provide, via a user interface element (e.g., a display) of the client computing device, a vision test for the user. Some examples of a vision test being provided to a user via a client computing device are disclosed in: U.S. Patent Publication No. 2013/0027668, to Pamplona, filed on Sep. 20, 2012, and entitled “NEAR EYE TOOL FOR REFRACTIVE ASSESSMENT,” the entire content of which is incorporated herein by reference and MIT News, Jun. 22, 2010, Chandler, David L., “In the World: Easy on the Eyes,” available at web.mit.edu/newsoffice/2010/itw-eyes.html, last visited Feb. 1, 2013. A user could focus his/her eyes on the display device, for example, in conjunction with a cover or other device to prevent the user from looking away from the display of the computing device, and a vision test can be provided to the user via the display device. In some examples, a vision test to determine a vision ability of a user can be provided via the client computing device 110, for example, by executing software code in the vision ability determination module 208. The user could be prompted to read characters of various font sizes and/or formats displayed on a screen of the computing device or indicate a direction in which an arrow on the screen is pointing. The distance from which the user reads the characters can be set to the distance from which the user typically views his/her computing device. For example, if a user typically views his/her computing device from 0.3-0.5 meters away, the user can read the characters from 0.3-0.5 meters away from the computing device. Alternatively, the distance may be set to closer or further than usual from the user to test for farsightedness or nearsightedness. For example, the user can provide a verbal response (e.g., saying “G” when the user sees the letter “G” on the screen) or press a button corresponding to a direction in which an arrow is pointing in response to the information displayed on the display device. For example, if an arrow is pointing to the left, the user can press a button on the left side of the screen or say the word “left.”

The vision ability determination module 208 is able to determine the user's vision ability based on the user's responses. For example, the determination could be based on a threshold font size where the user is able to read characters on the screen or a threshold arrow size at which the user is able to identify the direction of the arrow. For example, if the user cannot read characters below an 18 point font size on a screen 0.3-0.5 meters away from the user, the user is likely farsighted. The vision test may be similar to a vision test provided by an optometrist for the purpose of providing an eyeglasses prescription to the degree that both can involve the subject of the test reading characters or identifying directions of arrows presented to the subject. After completion of operation of the vision ability determination module 208, the determined vision ability of the user is stored in the visual ability information 210. The vision ability information 210 is provided, via software, to the UI setting(s) adjustment module 212. For example, the vision ability information 210 can be stored in a part of the memory 406 accessible to the UI setting(s) adjustment module 212.

The UI setting(s) adjustment module 212 is configured to adjust UI setting(s) 214 of the client computing device 110 based on the vision ability information 210. Vision information can be related to automatically generated user interface settings. For example, the more farsighted a user is, the larger a font size may be assigned to the computing device of the user. If a user is colorblind, the user's device may be set to display information in grayscale rather than in color. For example, the UI setting(s) adjustment module 212 can operate by changing the value(s) assigned to the UI setting(s) 214. The UI setting value(s) corresponding to the vision ability information can be stored either locally at the client computing device 110 or at the data repository 130. For example, if a user is determined to be farsighted (as determined, for example, by the vision ability determination module 208, using one or more of the vision test, manual input provided by the user, or the scan of the eyeglasses prescription), a default font size of the client computing device 110 may be increased or larger, more visible buttons may be provided on a touch screen of the client computing device 110. In some examples, the user can be determined to be farsighted based on a scan of the user's eyeglasses prescription. In some examples, upon activation of the vision ability determination module 208 and determination of the identity of the user (e.g., by having the user identify his/her account and enter a pin or password), the client computing device 110 can access the user's medical records to determine the user's eyeglasses prescription. The user affirmatively agrees to provide access to his/her medical records to the client computing device 110. The medical records may reside on a remote machine accessible to the client computing device via a network (e.g., the network 140). In some examples, the UI setting(s) adjustment module 212 operates by providing the vision ability information 210 to the data repository 130 for looking up associated user interface settings. In some examples, the UI setting(s) adjustment module 212 uses the network interface 204 to communicate with the data repository 130 via the network 140. Alternatively, a data structure indicating corresponding user interface setting(s) for various vision abilities may be stored locally at the client computing device 110. In some examples, the client computing device 110 stores settings for more common vision abilities and relies on the data repository 130 to receive settings relating to less common vision abilities. For example, settings for a vision ability held by 20% of a population (e.g., American adults) may be stored locally at the client computing device 110, while settings for a vision ability held by 0.1% of the population may be stored at the data repository 130 and provided to the client computing device 110 when needed. The UI setting(s) 214 can include one or more of a default font size, a default zoom level, a touch point size, a touch point sensitivity (e.g., users with poorer vision may want more sensitive touch points as such users may have difficulty locating and touching small touch points), or a color setting. In some examples, all or a part of the vision test may be repeated once every threshold time period (e.g., once every six months) to make sure that the settings of the client computing device 110 correspond to the most recent vision ability of the user. In some examples, parts of the vision test (e.g., tests corresponding to nearsightedness or farsightedness) are repeated more frequently than other parts of the vision test (e.g., tests corresponding to color blindness) as some aspects of a user's vision (e.g., nearsightedness or farsightedness) tend to change more frequently than other aspects of the user's vision (e.g., colorblindness). In some examples, testing for nearsightedness or farsightedness is conducted once every 6 months, while testing for colorblindness is conducted once per installation or system reset of the client computing device 110.

FIG. 3 illustrates an example of the server 120 of FIG. 1. As shown, the server 120 includes a central processing unit (CPU) 302, a network interface 304, and a memory 306. The CPU 302 includes one or more processors. The CPU 302 is configured to execute computer instructions that are stored in a computer-readable medium, for example, the memory 306. The network interface 304 is configured to allow the server 120 to transmit and receive data in a network, e.g., network 140 of FIG. 1. The network interface 304 may include one or more network interface cards (NICs). The memory 306 stores data or instructions. The memory 306 may be one or more of a cache unit, a storage unit, an internal memory unit (e.g., a hard disk internal to a computing device), or an external memory unit (e.g., a removable universal serial bus, compact disk, or floppy disk memory). As illustrated, the memory 306 includes a UI settings communication module 308 and an update data repository module 310.

The UI settings communication module 308 is configured to receive, from a client computing device (e.g., client computing device 110), an indication of a vision ability (e.g., vision ability information 210) of a user of the client computing device. The UI settings communication module 308 is configured to look up, in a data repository (e.g., data repository 130), user interface settings mapped to the received vision ability. The UI settings communication module 308 is configured to provide, to the client computing device, the user interface settings mapped, in the data repository, to the vision ability of the user. The user interface setting relates to a visual output of the client computing device.

The update data repository module 310 is configured to receive, from a predetermined number (e.g., three or sixty) of client computing devices, an indication that a specified user interface setting was manually updated to a specified value (e.g., a default font size was manually updated to 24 points), on each client computing device, to a specified value. Each of the client computing devices is associated with users having the same vision ability (e.g., users having −6 diopters vision, users having vision between −2 and −4 diopters, users having farsighted vision between 25/20 and 30/20, red-green colorblind users, users highly sensitive to light, etc.). As used herein, the phrase “N/20 farsighted vision” encompasses its plain and ordinary meaning. For example, a person with N/20 farsighted vision can see, at 20 feet away from him/herself, an object which a person with perfect vision would be able to see at N feet away from him/herself. The update data repository 310 module is configured to update one or more data structures in the data repository to map the same vision ability of the users of the client computing devices to the specified value for the specified user interface setting.

In some aspects, prior to execution of the update data repository module 310, the data repository includes a mapping of the vision ability of the users (e.g., vision between −2 and −4) to multiple values for a specified user interface setting (e.g., requesting for the user to choose between 18 point font and 24 point font) that include the specified value selected by the users (e.g., 24 point font). After execution of the update data repository module 310, the data repository includes a mapping of the vision ability of the users to only the specified value for the specified user interface setting.

Alternatively, prior to execution of the update data repository module 310, the data repository maps the vision ability of the users to a first user interface setting value. After execution of the update data repository module 310, the data repository maps the vision ability of the users to the specified user interface setting value selected by the users. For example, if the data repository stores that users having −3 vision should get a recommended 15 point font, and the predetermined number of users with −3 vision manually update their client computing devices to 18 point font, the data repository can be updated to reflect that users having −3 vision should get a recommended 18 point font, rather than the recommended 15 point font.

FIG. 4 illustrates an example of the data repository 130 of FIG. 1. As shown, the data repository 130 includes a central processing unit (CPU) 402, a network interface 404, and a memory 406. The CPU 402 includes one or more processors. The CPU 402 is configured to execute computer instructions that are stored in a computer-readable medium, for example, the memory 406. The network interface 404 is configured to allow the data repository 130 to transmit and receive data in a network, e.g., network 140 of FIG. 1. The network interface 404 may include one or more network interface cards (NICs). The memory 406 stores data or instructions. The memory 406 may be one or more of a cache unit, a storage unit, an internal memory unit (e.g., a hard disk internal to a computing device), or an external memory unit (e.g., a removable universal serial bus, compact disk, or floppy disk memory). As illustrated, the memory 406 includes a vision-UI setting(s) table 408.

The vision-UI setting(s) table 408 stores a mapping or a correspondence of vision ability score(s) 410.1-n to recommended UI setting(s) 412.1-n. While the vision-UI setting(s) table 408 is illustrate in FIG. 4 as a table, any other data structure, for example, an array, a matrix, a hash, a list, a queue, a stack, etc., can be used in place of a table to store the information stored in the vision-UI setting(s) table 408. In the vision-UI setting(s) table 408, each stored vision ability score 410.k has corresponding recommended UI setting(s) 412.k. A vision ability score 410.k can include one or more of a measure of nearsightedness or farsightedness, a measure of colorblindness, a measure of astigmatism, a measure of light sensitivity, or any information in an eyeglasses prescription. Recommended UI setting(s) can include any one or more UI settings, for example, a default font size, a default zoom level, a touch point size, a touch point sensitivity level, or color setting(s).

FIG. 5 is a flow chart illustrating an example process 500 for modifying a user interface setting based on a vision ability of a user.

The process 500 begins at step 510, where a computing device (e.g., client computing device 110) presents information output to a user of the computing device via user input/output element(s) (e.g., a display device internal or external to the computing device, such as a touch screen or a display device coupled with a mouse) of the computing device. For example, the computing device can provide a vision test to the user or ask the user to input his/her vision information (e.g., by scanning his/her prescription for corrective lenses or manually entering his/her vision information). The vision test is for determining the vision ability of the user.

In step 520, the computing device receives responsive user input via the user input/output element(s) of the computing device. For example, the user can take the vision test, scan his/her prescription for corrective lenses, or manually enter his/her vision information.

In step 530, the computing device analyzes the received responsive user input to automatically determine a vision ability of the user. For example, if the received responsive user input is a scan of a prescription for corrective lenses, the computing device can apply optical character recognition to the scan of the prescription to determine the user's vision information. If the received responsive user input is a response to a vision test, the computing device can determine the vision ability of the user based on the response to the vision test.

In step 540, the computing device automatically adjusts a setting of a user interface of the user input/output element(s) of the computing device based on the determined vision ability of the user. For example, if the user is farsighted, a default font size of the computing device can be increased. In some examples, the computing device determines, using a data repository (e.g., data repository 130) accessible via a communications network (e.g., network 140), user interface setting(s) corresponding to the determined vision ability and adjusts the setting(s) of the user interface according to the user interface setting(s) from the data repository. Alternatively, the user interface setting(s) can be determined based on information stored locally on the computing device. One example of automatically adjusting the setting of the user interface based on the determined vision ability of the user is illustrated in FIG. 6, below.

In step 550, the computing device further adjusts the user interface based on a manual selection from the user received via the input/output element(s). In some examples, the user is notified, via the computing device, of the automatically adjusted settings and/or the determined vision ability of the user. The user may receive, via the computing device, information suggesting further manual changes that other users with similar vision abilities have made to the setting(s) of their computing devices.

In some examples, the user is able to adjust the user interface settings only in a limited fashion. For example, the user may select between font sizes that are multiples of 6 points (e.g., 6 points, 12 points, 18 points, or 24 points) or between resolution levels within a certain range. The user may enter a number corresponding to a desired setting or manually select a number using up or down arrows on the computing device. In some examples, some user interface elements (e.g., some buttons) are adjusted based on the user's vision ability, while other user interface elements are not adjusted. For example, a user interface of a web browser application may be adjusted, while a user interface of a word processing application may not be adjusted.

In step 560, the computing device reports the determined vision ability of the user and the manual selection from the user through the communication network to the data repository for updating information about correspondence of user settings to users' vision abilities (e.g., vision-UI setting(s) table 408). After step 560, the process 500 ends.

FIG. 6 is a flow chart illustrating an exemplary process 600 for automatically adjusting the setting of the user interface based on the determined vision ability of the user. In some examples, the process 600 corresponds to the step 540 of FIG. 5.

The process 600 begins at step 610, where a client computing device (e.g., client computing device 110) determines, using a data repository (e.g., data repository 130), a user interface setting corresponding to a determined vision ability.

In step 620, the client computing device adjusts a setting of a user interface according to the user interface setting value corresponding to the determined vision ability. After step 620, the process 600 ends.

FIG. 7 is a flow chart illustrating an exemplary process 700 for providing a user interface setting to a client computing device.

The process 700 begins at step 710, where a server (e.g., server 120) receives, from a client computing device (e.g., client computing device 110), an indication of a vision ability of a user of the client computing device.

In step 720, the server provides, to the client computing device, a user interface setting for the client computing device mapped, in a data storage device (e.g., data repository 130), to the vision ability of the user. The user interface setting relates to a visual output of the client computing device.

In step 730, the server receives, from a predetermined number (e.g., 3 or 60) of client computing devices, an indication that a specified user interface setting (e.g., a color setting) was manually updated to a specified value (e.g., black and white color settings). The predetermined number may be set by a programmer setting up the server or based on a total number of client computing devices that modify setting(s) based on the user's vision (e.g., 0.1% or 0.01% of such devices). Each of the predetermined number of client computing devices is associated with a user having a first vision ability (e.g., color blindness). Each of the predetermined number of client computing devices may also be associated with a user having an age within an age range (e.g., between 15 and 20 years old, between 20 and 30 years old, etc.). Each of the predetermined number of client computing devices may also be associated with users having any other known characteristics, e.g., a specified gender, a specified geographic location, etc.

In step 740, the server updates one or more data structures (e.g., vision-UI setting(s) table 408) in the data storage device to map the first vision ability to the specified value for the specified user interface setting. After step 740, the process 700 ends.

FIGS. 8 and 9 provide functional block diagram illustrations of general purpose computer hardware platforms. FIG. 8 illustrates a network or host computer platform, as may typically be used to implement a server, for example, the server 120 of FIGS. 1 and 3. FIG. 9 depicts a computer with user interface elements, as may be used to implement a personal computer or other type of work station or terminal device, for example, the client computing device 110 of FIGS. 1 and 2, although the computer of FIG. 9 may also act as a server if appropriately programmed. It is believed that the general structure and general operation of such equipment as shown in FIGS. 8 and 9 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 9). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods of modifying a user interface setting based on a vision ability of a user outlined above may be embodied in programming, e.g. for a client computing device and/or for a server. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of the machine that will be the server and/or as an installation or upgrade of programming in a client computing device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the processes or systems shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computing device, comprising:
at least one user input/output element;
a processor configured to control operations of the computing device, including to provide a user interface via the at least one user input/output element;
a memory accessible to the processor; and
programming stored in the memory, wherein execution of the programming by the processor configures the computing device to implement functions, including functions to:
present information output for a user via the at least one user input/output element, receive responsive user input via the at least one user input/output element, and analyze the received responsive user input to automatically determine vision ability of the user; and
automatically adjust a setting of the user interface based on the determined vision ability of the user.

2. The computing device of claim 1, wherein execution of the programming by the processor configures the computing device to implement further functions, including functions to:
further adjust the adjusted user interface based on a manual selection from the user received via the at least user input/output element; and
report the determined vision ability of the user and the manual selection from the user through a communication network to a data repository for updating information about correspondence of user settings to users' vision abilities, wherein the data repository is accessible via a network.

3. The computing device of claim 2, wherein the function to automatically adjust the setting of the user interface based on the determined vision ability of the user comprises functions to:
determine, using the data repository, a user interface setting value corresponding to the determined vision ability; and
adjust the setting of the user interface according to the user interface setting value corresponding to the determined vision ability.

4. The computing device of claim 1, wherein the programming stored in the memory to automatically adjust the setting is configured to automatically adjust a setting related to a visual output of the computing device.

5. The computing device of claim 1, wherein the programming, stored in the memory, to present information output for the user comprises programming, stored in the memory, to present, for the user, a vision test on a display of the computing device, wherein the vision test is for determining a comfort level or an ability of the user to detect visual stimuli on the display.

6. The computing device of claim 1, wherein:
the responsive user input comprises a scan of a prescription for corrective lenses, and
the programming, stored in the memory, to analyze the received responsive user input configures the computing device to apply optical character recognition to the scan of the prescription for corrective lenses and analyze recognized characters of the prescription for corrective lenses to determine the vision ability of the user.

7. The computing device of claim 1, wherein the at least one user input/output element comprises a display device.

8. A computer system comprising:
a data storage device storing one or more data structures mapping vision abilities to user interface settings; and
a server coupled with the data storage device, the server comprising:
processing hardware; and
a server memory comprising a user interface settings module, the user interface settings module comprising instructions configured to be executed by the processing hardware, the instructions being for configuring the computer system to:
receive, from a client computing device, an indication of a vision ability of a user of the client computing device, and
provide, to the client computing device, a user interface setting for the client computing device mapped, in the data storage device, to the vision ability of the user, wherein the user interface setting relates to a visual output of the client computing device.

9. The computer system of claim 8, the server memory further comprising an update data storage device module, the update data storage device module comprising instructions configured to be executed by the processing hardware, the instructions being for configuring the computer system to:
receive, from a predetermined number of client computing devices, an indication that a specified user interface setting was manually updated to a specified value, wherein each of the predetermined number of client computing devices is associated with a user having a first vision ability; and
update the one or more data structures in the data storage device to map the first vision ability to the specified value for the specified user interface setting.

10. The computer system of claim 9, wherein:
prior to execution of the update data storage device module, the data storage device comprises a mapping of the first vision ability to plural values for the specified user interface setting, the plural values comprising the specified value, and
after execution of the update data storage device module, the data storage device comprises a mapping of the first vision ability to only the specified value for the specified user interface setting.

11. The computer system of claim 8, wherein the data storage device is separate and distinct from the server.

12. The computer system of claim 8, wherein the server comprises the data storage device, and wherein a single memory hardware unit comprises the server memory and the data storage device.

13. A method, comprising steps of:
presenting information output for a user of a computing device via at least one user input/output element of the computing device;
receiving responsive user input via the at least one user input/output element of the computing device;
analyzing the received responsive user input to automatically determine a vision ability of the user; and
automatically adjusting a setting of a user interface of the at least one user input/output element of the computing device based on the determined vision ability of the user.

14. The method of claim 13, further comprising:
further adjusting the adjusted user interface based on a manual selection from the user received via the at least one user input/output element; and
reporting the determined vision ability of the user and the manual selection from the user through a communication network to a data repository for updating information about correspondence of user settings to users' vision abilities, wherein the data repository is accessible via a network.

15. The method of claim 14, wherein automatically adjusting the setting of the user interface based on the determined vision ability of the user comprises:
determining, using the data repository, a user interface setting value corresponding to the determined vision ability; and
adjusting setting of the user interface according to the user interface setting value corresponding to the determined vision ability.

16. The method of claim 13, wherein the automatically adjusted setting relates to a visual output of the computing device.

17. The method of claim 16, wherein the automatically adjusted setting comprises one or more of a default font size, a default zoom level, a touch point size, a touch point sensitivity level, or a color setting.

18. The method of claim 13, wherein the information output for the user via the at least one user input/output element comprises a vision test for the user, wherein the vision test is presented on a display of the computing device, and wherein the vision test is for determining a comfort level or an ability of the user to detect visual stimuli on the display.

19. The method of claim 13, wherein:
the responsive user input comprises a scan of a prescription for corrective lenses, and
analyzing the received responsive user input to automatically determine the vision ability of the user comprises applying optical character recognition to the scan of the prescription for corrective lenses and analyzing recognized characters of the prescription for corrective lenses to determine the vision ability of the user.

20. A non-transitory machine-readable medium comprising instructions which, when executed by a computing device, cause the computing device to implement functions, including functions to:
present information output for a user of the computing device via at least one user input/output element of the computing device;
receive responsive user input via the at least one user input/output element of the computing device;
analyze the received responsive user input to automatically determine a vision ability of the user; and
automatically adjust a setting of a user interface of the at least one user input/output element of the computing device based on the determined vision ability of the user.
